(19) United States
(12) Patent Application Publication
(10) Pub. No.: US 2009/0134763 A1
(43) Pub. Date: May 28, 2009

(54) 3-Way parabolic reflector lamp

(76) Inventor: Jack V. Miller, Seaford, DE (US)

Correspondence Address: Jack V. Miller, 20915 Sussex Hwy., Seaford, DE, 19973, US

(21) Appl. No.: 11/986,648

(22) Filed: Nov. 26, 2007

(51) Int. Cl. H01K 1/28

(52) U.S. Cl. 313/115

(57) ABSTRACT

A 3-way reflector lamp includes a parabolic reflector (3) mounted on a 3-way lamp base having screw shell, a center contact and an intermediate contact. The reflector has its focus on its optical axis proximal end and extends in the distal direction. A first filament is connected to the screw shell and center contact, whereby light from the first filament is collimated by into a spotlight beam, and a second filament on the optical axis is spaced in the distal direction from the first filament and connected to the screw shell and an intermediate ring contact, whereby light from the energized second filament is diffused into a floodlight beam, and light from both energized filaments produces a spotlight beam within the floodlight beam.

### US PATENT REFERENCES CITED

U.S. Pat. No. 4,105,276—Miller
U.S. Pat. No. 4,161,020—Miller
U.S. Pat. No. 3,432,723—Miller
U.S. Pat. No. 5,099,399—Miller, et al.
U.S. Pat. No. 4,420,799—Miller
U.S. Pat. No. 4,349,768—Miller
U.S. Pat. No. 4,178,535—Miller
U.S. Pat. No. 4,367,434—Miller
D-215,480—Miller
U.S. Pat. No. 4,302,698—Kiesel, et al.
U.S. Pat. No. 6,919,684—Brandes

### FIELD OF THE INVENTION

The present invention relates to the field of incandescent lamps, 3-way incandescent lamps and more specifically parabolic reflector lamps known as PAR lamps, commonly used in residential and commercial buildings.

### BRIEF DESCRIPTION OF THE DRAWINGS

FIG. 1 is a drawing of a prior art MR-16 miniature reflector lamp;

FIG. 2 is a drawing of a prior art PAR-38 reflector lamp; and

FIG. 3 is a drawing of a 3-way reflector lamp of the present invention.

### BACKGROUND OF THE INVENTION

Parabolic reflector lamps are the most popular lamps used in general lighting for commercial buildings. They are usually identified in the lighting industry as “PAR” lamps, in which a light source, such as an incandescent filament or gas-discharge capsule is oriented at the focal point of a parabolic reflector. Such PAR lamps employ integral screw bases or bi-pin bases that are supported within lamp sockets connected to remote sources of electrical power.

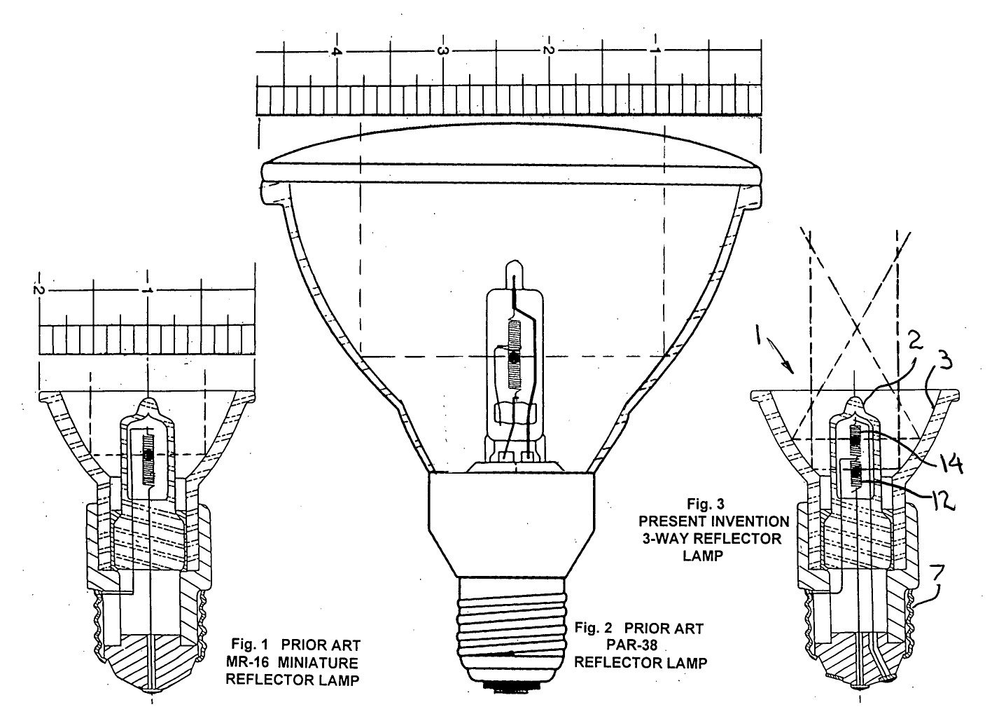

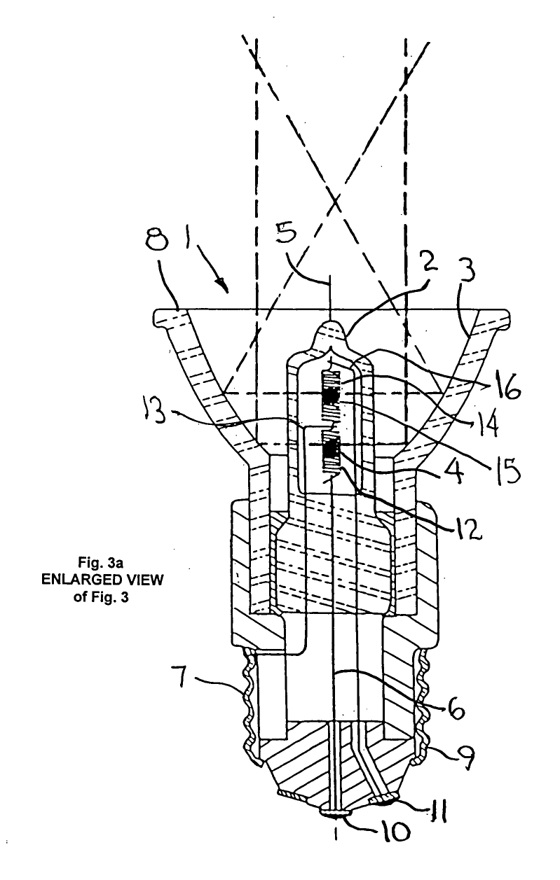

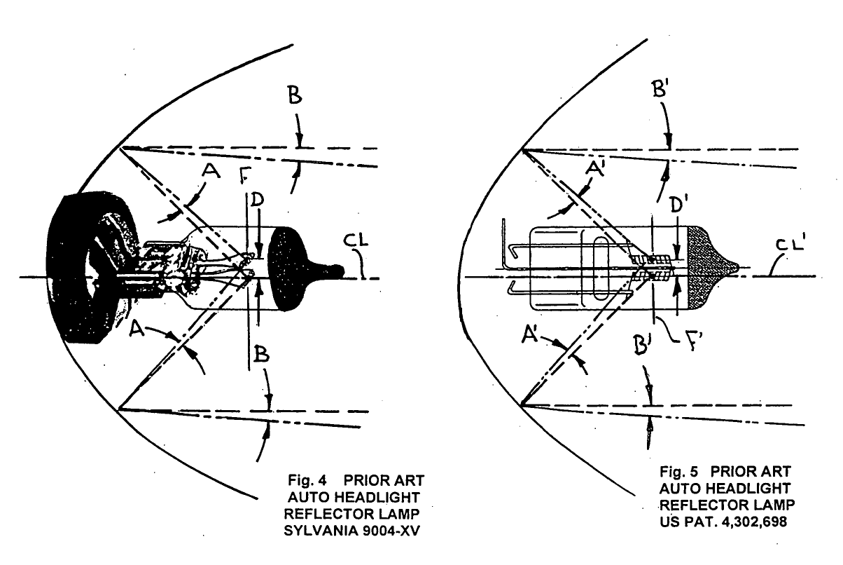

The reflectors of PAR lamps are normally classified by reflector rim diameter, such as MR-16 (Miniature Reflector, 16 ⅛ths of an inch, or 2-inches in diameter) as shown in Prior art FIG. 1, up through PAR 38 lamps (38 ⅛ths of an inch, or 4¾-inches in diameter), as shown in Prior art FIG. 2.

Over recent years parlamps have grown in popularity, compared to fluorescent lamps, because their light sources (incandescent filaments) are small enough to be sharply focused. The MR-16 lamp is widely used because it can be made in a 10° or 20° spotlight that fits in small downlights and tracklights. The typical filament structure of a tungsten-halogen light capsule used in an MR-16 is shown in FIG. 1. Since the filament shown is designed for 120-volt operation it typically uses a coiled coil filament.

In lamps having large reflectors, such as the prior art PAR 38 lamp of FIG. 2, a simple coiled 120-volt filament is long and fragile, and hence must have the mechanical center support shown, that is not connected to the power source.

In the quest for less energy use, many incandescent lighting systems, using inexpensive lamps, employ dimmers that reduce the light output of the lamp. This an ineffective method, as a 50% reduction in light output reduces the filament temperature, shifting more lamp energy into the infrared band. Thus dimming the light by 50% only reduces the power consumption by 10%. Further, the dimmed light becomes more yellow-orange in color. Since human eyes see most efficiently in the green portion of the visible spectrum at 560 nm (nanometer wavelength), dimming results in poor visual efficiency. Then the energy saving is often offset by turning up the light level.

Residential use of 3-way incandescent lamps maintains the color temperature of the light by using 2 filaments of unequal wattage that are illuminated separately or together, usually at 30-60-100 watts. The light levels are changed by a rotary switch in portable lamps, such as table lamps or floor lamps. However these are only currently available as A-type lamps having the typical “light bulb” spherical-end shape, and thus are used almost exclusively in a lamps in private residences.

One energy-saving light source is the self-ballasted, screw-base, compact fluorescent lamp that screws directly into a medium screw-base socket. This applicant is very familiar with such products as the inventor of the energy-efficient circuline fluorescent converters shown in U.S. Pat. Nos. 4,161,020; 4,420,799; 4,105,276; 3,432,723; 4,349,768; and D-215,480; 3-way fluorescent converters U.S. Pat. No. 4,178,535; and U.S. Pat. No. 4,367,434. These patents date back 30 years, and the products were sold in retail stores. However cheap energy at the time limited sales of converters costing many times more than an ordinary light bulbs.

Now the high cost of energy dictates a need for energy conservation and justifies the added expense of the currently-available spiral-tube compact fluorescent lamps. The return on investment in lamps is acceptable in commercial buildings using hundreds or even thousands of downlight and/or tracklights. These lamps are very efficient in terms of lumens per watt, but the relatively large luminous areas of “compact” fluorescent lamps are not all that compact, and thus cannot be focused or aimed effectively. The result is an overall “wash” of relative bright light that often under-illuminates task areas, while over-lighting unoccupied open areas including the floors.

Human vision is not directly proportional to light levels, but is also dependent on a factor called “CRI” (Color Rendition Index). A perfect CRI rating of 100 means that an average person viewing an array of color sample chips of graduated colors, can correctly place 100% of the chips in their correct sequence in the color spectrum. An incandescent light source has a continuous, uninterrrupted SPD (Spectral Power Distribution) with no gaps in its spectral output from the UV (ultravionet) limit at 380 nm wavelength, through the visible spectrum, to the IR (infrared) limit at 770 nm.

However, in the quest for high lumens per watt, fluoreescent lamps are designed as “tri-stimulus” lamps that stimulate each of three separate color sensors in the human eye. The gaps between the three spikes of fluorescent light output provide a CRI of only about 80, meaning that a person can only correctly place 80% of the test chips in their correct order in the spectrum. Thus human visual efficiency is about 20% lower with fluorescent light than incandescent light.

Further, fluorescent lamps, and particularly high-output spiral compact fluorescent lamp, are based on mercury emissions used to energize those tri-stimulus light-emitting phosphors. Thus the lamps emit about 6% of their total output as ultraviolet energy and approximately 70% of their energy as IR heat. These invisible “light” bands are known to cause photochemical damage to everything from textiles to meats and bananas, while contributing nothing to vision.

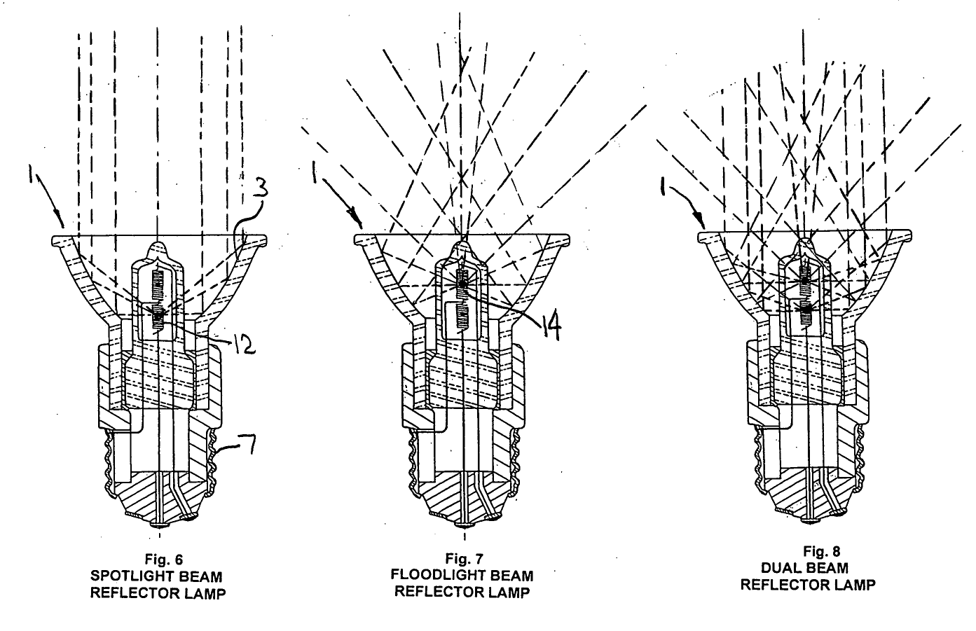

The shortcomings of fluorescent lamps raises the need for full-spectrum incandescent lamps that can have remotely switched 3-way operation using 2 small filament light sources, such as the present invention as shown in FIG. 3. Such lamps can be easily used in small light fixtures that have appropriate filters to remove all UV and IR energy from the light beam. Such fixtures are manufactured under the trade name “NoUVIR”, an acronym for lights with no UV or IR.

### DETAILED DESCRIPTION OF THE DRAWINGS

The present invention as shown in FIGS. 3 and 3a is for a generally circular 3-way parabolic reflector lamp (1) having a tungsten-halogen lamp (2) in a parabolic reflector (3). The reflector has a focus (4) on an optical axis (5) from a proximal end (6) at a 3-way lamp base (7) and extending in the distal direction to the rim (8) of reflector (3). The 3-way lamp base has a screw shell (9) and an insulated center power contact (10) within and insulated from an intermediate power contact (11) is insulated from and attached to screw shell (9).

The tungsten-halogen lamp (2) has a first incandescent filament (12) on the optical axis, with a proximal end connected to the center contact of the lamp base and extending on the optical axis in the distal direction to a distal end support (13) and having an LCL (light center line) approximately at the focus (4) of reflector (3). Distal end support (13) is electrically connected to neutral male screw shell (9).

A second incandescent filament (14) on the optical axis has a proximal end first filament support (12) at the distal end of the first filament and extends in the distal direction on the optical axis, with an LCL (15) displaced from the focus of the reflector and having a distal end supported and connected to second filament support (16), connected to the intermediate contact (11) of the lamp base.

In FIG. 3, energizing first filament 12 at the focus of the reflector produces a generally collimated spotlight beam and energizing the second filament 14 produces a generally diffuse floodlight beam, and both filaments are contained in a halogen gas filled quartz capsule.

Prior art FIGS. 4 and 5 show the clear differences between the present invention and 3-way tungsten-halogen automobile headlight lamps. Headlight lamps have optical centerlines CL and CL′ in parabolic reflectors with focal planes F and F′ transverse to the optical centerlines. The lower filament in each configuration is the high-beam filament, centered on the optical centerline and produced collimated light parallel to the optical centerline. The upper filaments are displaced above the optical centerline forming angles A and A′ between the two filaments and the reflector and reflecting light at angles B and B′, respectively, to form a low beam. Both 3-way lamps provide have filaments in the same focal plane, and thus neither of them is capable of producing narrow spotlight and/or wide floodlight beams.

FIG. 6 shows a 3-way parabolic reflector lamp according to the invention having the first filament (12) energized and producing substantially collimated spotlight beam.

FIG. 7 shows a 3-way parabolic reflector lamp according to the invention having the second filament (14) energized and producing substantially diffused floodlight beam.

FIG. 8 shows a 3-way parabolic reflector lamp according to the invention having both the first filament (12) and the second filament (14) both energized and producing a substantially collimated spotlight beam within a substantially diffused floodlight beam.

### SUMMARY OF THE INVENTION

A 3-way reflector lamp (1) according to the invention includes a parabolic reflector (3) mounted on a 3-way lamp base (7) having screw shell (9), a center contact (10) and an intermediate contact (11). The reflector has its focus on an optical axis (5) with a proximal end at the reflector focus (4) and extending in the distal direction. A first filament (12) is connected to the screw shell and center contact, whereby light from the first filament is collimated by the reflector into a spotlight beam, and a second filament (14) on the optical axis is spaced in the distal direction from first filament (12) and connected to screw shell (9) and an intermediate ring contact (11), whereby light from energized second filament (14) is diffused into a floodlight beam.

1. A 3-way parabolic reflector lamp including:
a generally circular lamp (1) including a parabolic reflector (3) with its focus (4) on an optical axis (5), said reflector (3) having a proximal end supported and extending in the distal direction from a 3-way lamp base (7) comprising a screw shell, and an insulated center power contact (10) surrounded by and insulated from an intermediate power contact (11), in turn insulated from and attached to screw shell (9);
a first incandescent filament (12) disposed within reflector (3), having a proximal end near the proximal end of the optical axis and electrically connected to the center contact (10) of the lamp base, said filament (12) extending on the optical axis in the distal direction and having a distal end supported on optical axis (5) and electrically connected by a support (13) to an electrically neutral screw shell (9);
a second incandescent filament (14) on the optical axis (5), having a proximal end connected to the distal end of the first filament (12), extends in the distal direction on the optical axis, supported and connected thereat and electrically connected to the intermediate contact (11) of the lamp base (7);

2. A 3-way parabolic reflector lamp (1) according to claim 1 in which electrical power applied between the neutral screw shell (7) and center power contact (10) of the lamp base energizes the first filament (12), electrical power applied between the neutral screw shell (9) and the intermediate contact (11) energizes the second filament (14), and electrical power applied between the neutral screw shell (9) and both the center and intermediate contacts energizes both filaments.

3. A 3-way parabolic reflector lamp (1) according to claim 1 in which the first filament (12) has an optical center located at the focus (4) of the parabolic reflector (3) whereby light emitted from said first filament is substantially collimated into a spotlight beam, and the second filament (14) has an optical center (15) displaced in the distal direction from focus (4) of the reflector, whereby light emitted from the second filament is substantially out of focus, forming a floodlight beam, and whereby light emitted from both filaments emits a spotlight beam in the center of the floodlight beam.

4. A 3-way parabolic reflector lamp (1) according to claim 1 in which the filaments (12, 14) disposed within the reflector (3) are contained in a transparent glass or quartz capsule (2) including an inert halogen gas.
